(19) United States
(12) Patent Application Publication
(10) Pub. No.: US 2013/0035077 A1
(43) Pub. Date: Feb. 7, 2013

(54) ELECTRONIC DEVICE, STORAGE MEDIUM AND METHOD FOR REMOTELY CONTROLLING HOUSEHOLD ELECTRIC APPLIANCES

(71) Applicant: Cheng-Yu TSAI, Tu-Cheng (TW)

(72) Inventor: Cheng-Yu TSAI, Tu-Cheng (TW)

(73) Assignee: HON HAI PRECISION INDUSTRY CO., LTD., Tu-Cheng (TW)

(21) Appl. No.: 13/437,045

(22) Filed: Apr. 2, 2012

(30) Foreign Application Priority Data
Aug. 2, 2011 (TW) 100127315

(51) Int. Cl. H04W 4/00

(52) U.S. Cl. 455/414.1

(57) ABSTRACT

In a method for remotely controlling household electric appliances using an electronic device, a check request is acquired from a mobile phone. The electronic device transmits the check request to each of the household electric appliances. Then the electronic device acquires status information and an identifier of each of the household electric appliance, and transmits all the items of status information, and the identifiers, to the mobile phone. The electronic device further acquires an identifier and a control command of a target household electric appliance from the mobile phone, to turn on or turn off the household electric appliance as the case may be.

### BACKGROUND

1. Technical Field

Embodiments of the present disclosure relate to the field of remote control, and more particularly, to an electronic device, a storage medium, and a method for remotely controlling household electric appliances using the electronic device.

2. Description of Related Art

Many remote control devices, such as infrared control devices and BLUETOOTH control devices may be used for remotely controlling household electric appliances, such as television sets and air-conditioning equipments. However, such household electric appliances can be remotely controlled only within a very short range of these remote control devices. Users cannot remotely control their household electric appliances from outside their house using these types of remote control devices. In addition, if the users leave home and forget to switch the household electric appliances off, there is the risk of damage by fire.

### BRIEF DESCRIPTION OF THE DRAWINGS

FIG. 1 is a block diagram of one embodiment of an electronic device including a remote control system.

FIG. 2 is a block diagram of one embodiment of functional modules of the remote control system included in the electronic device of FIG. 1.

FIG. 3 is a flowchart of one embodiment of a method for remotely controlling household electric appliances using the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

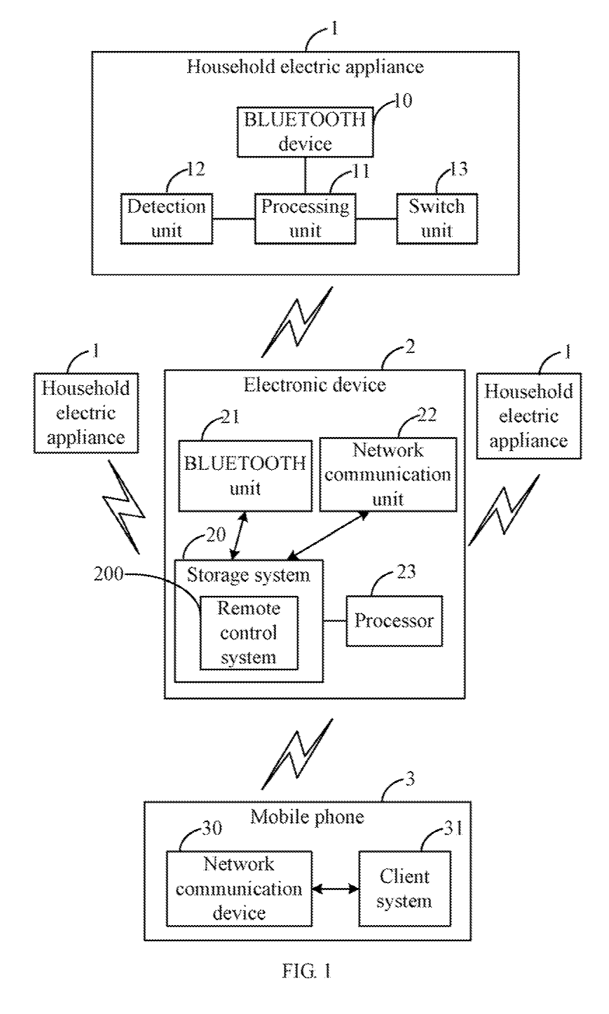

FIG. 1 is a block diagram of one embodiment of an electronic device 2 including a remote control system 200, which is used for remotely controlling household electric appliances 1. In the embodiment, the electronic device 2 further includes a storage system 20, a BLUETOOTH unit 21, a network communication unit 22, and at least one processor 23. The remote control system 200 may be in the form of one or more programs stored in the storage system 20 and executed by the at least one processor 23. FIG. 1 is just one example of the electronic device 2 that can be included with more or fewer components than shown in other embodiments, or have a different configuration of the components. The electronic device 2 may be, for example, a mobile phone, a personal digital assistant, a handheld computer, or a desktop computer.

In the embodiment, each of the household electric appliances 1, such as a television set or air-conditioning equipments, includes a BLUETOOTH device 10. Furthermore, each of the household electric appliances 1 has a unique identifier. The identifier may be defined as a device number of each household electric appliance 1. If the electronic device 2 communicates with the household electric appliances 1 via the BLUETOOTH unit 21 and the BLUETOOTH device 10, the electronic device 2 can identify each of the household electric appliances 1 according to the device number of each household electric appliance 1.

In the embodiment, the electronic device 2 further communicates with a mobile phone 3 via a wireless network, such as a 3G telecommunications network. The mobile phone 3 includes a network communication device 30. The electronic device 2 communicates with the mobile phone 3 via the network communication unit 22 and the network communication device 30. The user can carry the mobile phone 3 and remotely control the household electric appliances 1 through the mobile phone 3 and the electronic device 2 at any time.

Each of the household electric appliances 1 further includes a processing unit 11, a detection unit 12, and a switch unit 13. The detection unit 12 is configured to detect status information of each household electric appliance 1. The status information may include a power-on status or a power-off status, a power consumption value, an operating temperature, an operating current and an operating voltage of each household electric appliance 1. The status information is transmitted to the electronic device 2 via the BLUETOOTH device 10 and the BLUETOOTH unit 21, and is then transmitted to the mobile phone 3 via the network communication unit 22 and the network communication device 30.

The mobile phone 3 further includes a client system 31. The client system 31 is configured to display the status information on a screen of the mobile phone 3 and generate a control command for controlling a target household electric appliance 1 to be turned on or turned off according to requirements of the user. For example, if the user checks that a television set is very hot, the user can input operation information to the client system 31 to turn off the television set.

The client system 31 further transmits the control command to the household electric appliance 1. The control command are transmitted to the electronic device 2 via the network communication device 30 and the network communication unit 22, and then transmitted to the household electric appliance 1 via the BLUETOOTH unit 21 and the BLUETOOTH device 10.

The processing unit 11 of the household electric appliance 1 acquires the control command, and sends the control command to the switch unit 13. The switch unit 13 controls the household electric appliance 1 to be turned on or turned off according to the control command. The processing unit 11 may be a single-chip microcomputer.

In one embodiment, the storage system 20 may be a random access memory (RAM) for temporary storage of information, and/or a read only memory (ROM) for permanent storage of information. In other embodiments, the storage system 20 may also be an external storage device, such as a hard disk, a storage card, or a data storage medium. The at least one processor 23 executes computerized operations of the electronic device 2 and other applications, to provide functions of the electronic device 2.

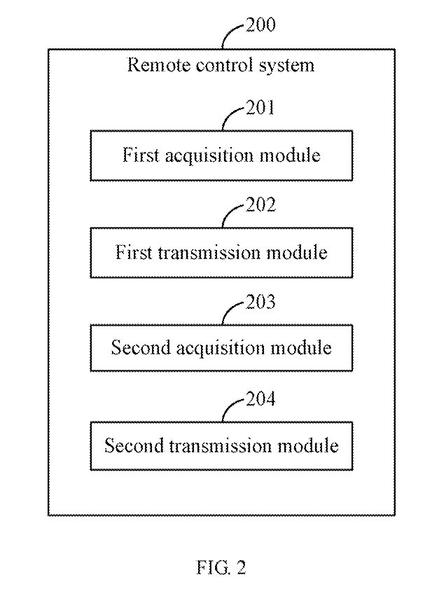

FIG. 2 is a block diagram of one embodiment of functional modules of the remote control system included in the electronic device of FIG. 1. In the embodiment, the remote control system 200 may include a first acquisition module 201, a first transmission module 202, a second acquisition module 203, and a second transmission module 204. The modules 201-204 may comprise a plurality of functional modules each comprising one or more programs or computerized codes that can be accessed and executed by the at least one processor 23. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

The first acquisition module 201 acquires a check request from the mobile phone 3 via the network communication unit 22. When the user starts up the client system 31 of the mobile phone 3, or wishes to refresh the status information displayed by the client system 31, the client system 31 generates the check request and transmits the check request to the electronic device 2 via the network communication device 30. The check request requires the status information of each of the household electric appliances 1.

The first transmission module 202 transmits the check request to each of the household electric appliances 1 via the BLUETOOTH unit 21. The processing unit 11 of each household electric appliance 1 acquires the check request via the BLUETOOTH device 10, and transmits the check request to the detection unit 12. The detection unit 12 detects the status information of each household electric appliance 1 according to the check request. The processing unit 11 of each electrical appliance 1 transmits the status information to the electronic device 2 via the BLUETOOTH device 10.

The second acquisition module 203 acquires the different items of status information and the identifier of each household electric appliance 1 via the BLUETOOTH unit 21. The identifier may be a device number of each household electric appliance 1.

The second transmission module 204 transmits the identifier and the status information of each household electric appliance 1 to the mobile phone 3 via the network communication unit 22. The client system 31 of the mobile phone 3 displays all the identifiers and the status information on the screen of the mobile phone 3. When the user inputs operation information to the client system 31, for turning on or turning off a target household electric appliance 1, the client system 31 generates a control command according to the input operation information. The client system 31 transmits the control command and the identifier of the household electric appliance 1 to the electronic device 2 via the network communication device 30.

The first acquisition module 201 further acquires the control command and the identifier of the household electric appliance 1 from the mobile phone 3 via the network communication unit 22.

The first transmission module 202 further transmits the control command to the household electric appliance 1 corresponding to the identifier of the household electric appliance 1, via the BLUETOOTH unit 21. The processing unit 11 of the household electric appliance 1 acquires the control command via the BLUETOOTH device 10, and the switch unit 13 controls the household electric appliance 1 to be turned on or turned off according to the control command.

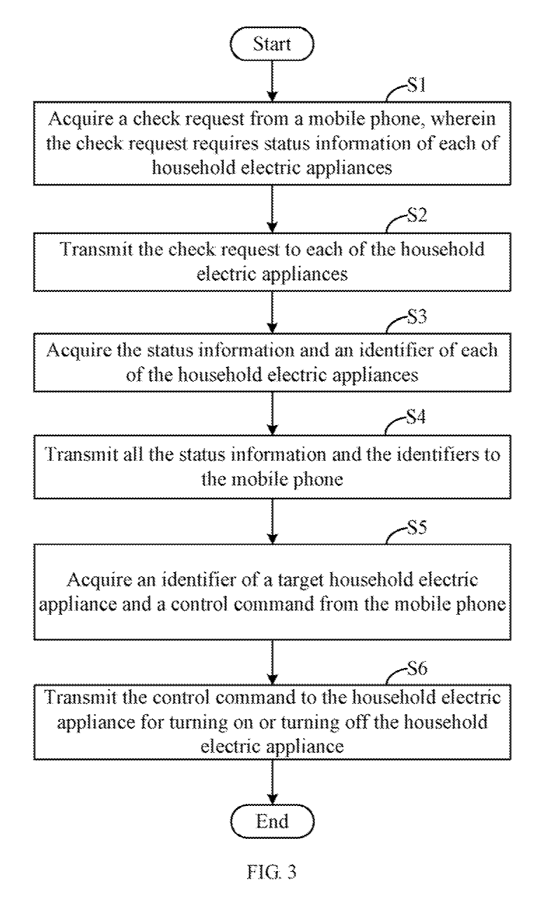

FIG. 3 is a flowchart of one embodiment of a method for remotely controlling household electric appliances using the electronic device 2 of FIG. 1. Depending on the embodiment, additional steps may be added, others removed, and the ordering of the steps may be changed.

In step S1, the first acquisition module 201 acquires a check request from the mobile phone 3 via the network communication unit 22. The check request requires status information of each of the household electric appliances 1. As mentioned above, the status information may include a power-on status or a power-off status, a power consumption value, an operating temperature, an operating current and an operating voltage of each household electric appliance 1.

In step S2, the first transmission module 202 transmits the check request to each of the household electric appliances 1 via the BLUETOOTH unit 21.

In step S3, the second acquisition module 203 acquires the responses, in the form of status information and an identifier of each household electric appliance 1, via the BLUETOOTH unit 21.

In step S4, the second transmission module 204 transmits the identifier and the status information of each household electric appliance 1 to the mobile phone 3 via the network communication unit 22.

In step S5, the first acquisition module 201 acquires a control command and an identifier of a target household electric appliance 1 from the mobile phone 3 via the network communication unit 22. The control command is used for controlling the household electric appliance 1 to be turned on or turned off.

In step S6, the second transmission module 202 transmits the control command to the household electric appliance 1 corresponding to the identifier of the household electric appliance 1, via the BLUETOOTH unit 21. The processing unit 11 of the household electric appliance 1 acquires the control command via the BLUETOOTH device 10, and the switch unit 13 of the household electric appliance 1 is activated, to turn the household electric appliance 1 on or off according to the control command

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a storage system;
at least one processor;
one or more programs stored in the storage system and executed by the at least one processor, the one or more programs comprising:
a first acquisition module that acquires a check request from a mobile phone, wherein the check request requires status information of each of a plurality of household electric appliances;
a first transmission module that transmits the check request to each of the household electric appliances;
a second acquisition module that acquires the status information and an identifier of each of the household electric appliances;
a second transmission module that transmits all the status information and the identifiers to the mobile phone;
the first acquisition module that further acquires an identifier of a target household electric appliance and a control command for controlling the household electric appliance to be turned on or turned off from the mobile phone; and
the first transmission module that further transmits the control command to the household electric appliance corresponding to the identifier of the household electric appliance, and controls the household electric appliance to be turned on or turned off according to the control command

2. The electronic device of claim 1, wherein the electronic device communicates with the mobile phone via a network communication unit of the electronic device.

3. The electronic device of claim 1, wherein each of the household electric appliances comprises a BLUETOOTH device for communicating with the electronic device.

4. The electronic device of claim 3, wherein the electronic device communicates with each of the household electric appliances via a BLUETOOTH unit of the electronic device and the BLUETOOTH device of each of the household electric appliances.

5. The electronic device of claim 4, wherein the identifier is defined as a device number of each of the household electric appliances.

6. The electronic device of claim 1, wherein the status information comprise a power-on status or a power-off status, a power consumption value, an operating temperature, an operating current and an operating voltage of each of the household electric appliances.

7. A method for remotely controlling a plurality of household electric appliances using an electronic device, the method comprising:
(a) acquiring a check request from a mobile phone, wherein the check request requires status information of each of the household electric appliances;
(b) transmitting the check request to each of the household electric appliances;
(c) acquiring the status information and an identifier of each of the household electric appliances;
(d) transmitting all the status information and the identifiers to the mobile phone;
(e) acquiring an identifier of a target household electric appliance and a control command for controlling the household electric appliance to be turned on or turned off from the mobile phone; and
(f) transmitting the control command to the household electric appliance corresponding to the identifier of the household electric appliance, and controlling the household electric appliance to be turned on or turned off according to the control command

8. The method of claim 7, wherein the electronic device communicates with the mobile phone via a network communication unit of the electronic device.

9. The method of claim 7, wherein each of the household electric appliances comprises a BLUETOOTH device for communicating with the electronic device.

10. The method of claim 9, wherein the electronic device communicates with each of the household electric appliances via a BLUETOOTH unit of the electronic device and the BLUETOOTH device of each of the household electric appliances.

11. The method of claim 10, wherein the identifier is defined as a device number of each of the household electric appliances.

12. The method of claim 7, wherein the status information comprises a power-on status or a power-off status, a power consumption value, an operating temperature, an operating current and an operating voltage of each of the household electric appliances.

13. A non-transitory storage medium storing a set of instructions, the set of instructions capable of being executed by a processor of an electronic device, causes the electronic device to execute a method for remotely controlling a plurality of household electric appliances, the method comprising:
(a) acquiring a check request from a mobile phone, wherein the check request requires status information of each of the household electric appliances;
(b) transmitting the check request to each of the household electric appliances;
(c) acquiring the status information and an identifier of each of the household electric appliances;
(d) transmitting all the status information and the identifiers to the mobile phone;
(e) acquiring an identifier of a target household electric appliance and a control command for controlling the household electric appliance to be turned on or turned off from the mobile phone; and
(f) transmitting the control command to the household electric appliance corresponding to the identifier of the household electric appliance, and controlling the household electric appliance to be turned on or turned off according to the control command

14. The storage medium of claim 13, wherein the electronic device communicates with the mobile phone via a network communication unit of the electronic device.

15. The storage medium of claim 13, wherein each of the household electric appliances comprises a BLUETOOTH device for communicating with the electronic device.

16. The storage medium of claim 15, wherein the electronic device communicates with each of the household electric appliances via a BLUETOOTH unit of the electronic device and the BLUETOOTH device of each of the household electric appliances.

17. The storage medium of claim 16, wherein the identifier is defined as a device number of each of the household electric appliances.

18. The storage medium of claim 13, wherein the status information comprises a power-on status or a power-off status, a power consumption value, an operating temperature, an operating current and an operating voltage of each of the household electric appliances.
